(19) United States
(12) Patent Application Publication
(10) Pub. No.: US 2025/0298460 A1
(43) Pub. Date: Sep. 25, 2025

(54) DEVICE AND A SYSTEM FOR INTERACTION WITH A USER

(71) Applicants: Wintom Zecarias, Helsinki (FI); Filmon Zecarias, Helsinki (FI)

(72) Inventors: Wintom Zecarias, Helsinki (FI); Filmon Zecarias, Helsinki (FI)

(21) Appl. No.: 18/611,393

(22) Filed: Mar. 20, 2024

(51) Int. Cl. G06F 3/01; G06Q 30/0251

(52) U.S. Cl. CPC G06F 3/011; G06Q 30/0268

(57) ABSTRACT

The disclosed device includes a communication module configured to communicate with a remote device over a wireless connection, a motion sensor arrangement configured to detect motion data pertaining to the device, at least one signaling element for indicating to a device user, and a controller unit coupled to the communication module, the motion sensor arrangement, and the at least one signaling element; wherein the controller unit is configured to receive motion data pertaining to the device from the motion sensor arrangement, analyze the motion data pertaining to the device, transmit a result of said analysis to said remote device, via the communication module, receive information about an indication to be provided to a user of the device, via the communication module, and provide an indication to a user via a signalling element based at least in part on said received information. A system for the same is also disclosed.

### BACKGROUND OF THE INVENTION

### Field of the Invention

The present disclosure relates generally to interacting with users and managing information within retail environments; and more specifically, to devices and systems for interacting with users and managing information.

### Description of Related Art

In recent years, online shopping has revolutionized the retail industry. However, a large sect of people still prefer to shop at brick and mortar stores, like retail stores, for example Wal-Mart, Costco, Kroger and the like. Typically, people shopping in such stores would like to spend time in physically evaluating worth of articles they would like to buy. In the process, owners of such stores try to manage articles for sale in such a way that provides pleasant shopping experiences to buyers or consumers. For example, articles of same nature are kept in one place, largely bought articles are kept at beginning of the stores, visual representations are provided for guiding buyers through different sections of the articles, audio and video entertainment systems are arranged in various parts of the stores, and the like. Although, great care is taken by the owners of the stores to improve the overall shopping experience for the buyers, but that can be further improved with buyer's feedback. Also, the buyer's feedback can be used in various ways in order to improve overall business for such stores.

However, collecting buyer's feedback in such brick and mortar stores is associated with numerous challenges. For example, asking questions and taking feedback with respect to such questions either orally or in a written manner is a substantially time consuming task. Further, there are alternatives available for acquiring buyer's feedback apart from oral and written manner. For example, such stores may be equipped with touch sensitive display devices that present simple questions like “happy or sad with shopping experience” to a buyer; and the buyer provides his or her feedback by selecting one of the options (i.e. happy or sad). However, such devices require space and specific locations for their installation, and also such devices are designed to present limited questions for acquiring buyer's feedback.

Therefore, in light of the foregoing discussion, there exists a need to overcome the aforementioned drawbacks associated conventional ways of acquiring buyer's feedback in a retail store environment.

### BRIEF SUMMARY OF THE INVENTION

The present disclosure seeks to provide a device for interaction with a user. The present disclosure also seeks to provide a system for managing information. The present disclosure seeks to provide a solution to the existing problem of difficulty in presenting information to and obtaining feedback from buyers in a retail environment. An aim of the present disclosure is to provide a solution that overcomes at least partially the problems encountered in the prior art, and provides an inexpensive, interactive, and simple device for efficiently managing information.

In one aspect, an embodiment of the present disclosure provides a device for interaction with a user, the device comprising:

a communication module configured to communicate with a remote device over a wireless connection;

a motion sensor arrangement configured to detect motion data pertaining to the device;

at least one signalling element for providing an indication to a user of the device,

a controller unit coupled to the communication module, the motion sensor arrangement, and the at least one signalling element, wherein the controller unit is configured to:

receive the motion data pertaining to the device from the motion sensor arrangement;

analyse the motion data pertaining to the device;

transmit a result of said analysis to said remote device, via the communication module;

receive information about an indication to be provided to a user of the device, via the communication module, and

provide an indication to a user via a signaling element based at least in part on said received information.

In another aspect, an embodiment of the present disclosure provides a system for managing information, the system comprising:

a computing device having a display;

at least one device for interaction with a user, the device comprising:

a communication module configured to communicate with said computing device over a wireless connection;

a motion sensor arrangement configured to detect motion data pertaining to the device;

at least one signalling element for providing an indication to a user of the device,

a controller unit coupled to the communication module, the motion sensor arrangement, and the at least one signalling element, wherein the controller unit is configured to:

receive the motion data pertaining to the device from the motion sensor arrangement;

analyse the motion data pertaining to the device;

transmit a result of said analysis to said computing device, via the communication module;

receive information about an indication to be provided to a user from said computing device via the communication module, and

provide an indication to a user via a signaling element based at least in part on said received information,

said computing device being arranged to display information on said display to a user based on information received from said device for interaction with a user.

Embodiments of the present disclosure substantially eliminate or at least partially address the aforementioned problems in the prior art, and enables efficient management of information within an environment, for example, such as a retail environment.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE SEVERAL VIEWS OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an environment for using a device for managing information, in accordance with an embodiment of the present disclosure;

FIG. 2 is an illustration of an orientation of the device with respect to a three-dimensional coordinate system, in accordance with an embodiment of the present disclosure;

FIGS. 3A and 3B are schematic illustrations of architectures of the device, in accordance with different embodiments of the present disclosure;

FIG. 4 is a schematic illustration of a power source arrangement employed to provide electrical power to the device, in accordance with an embodiment of the present disclosure;

FIG. 5 is an illustration of detected motion data pertaining to the device, in accordance with an embodiment of the present disclosure;

FIG. 6 illustrates steps of a method for managing information via a device, in accordance with an embodiment of the present disclosure;

FIG. 7 illustrates a system for managing information in accordance with an embodiment of the present disclosure, and

FIG. 8 illustrates a further system for managing information in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE INVENTION

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a device for managing information, the device comprising:

a communication module configured to communicate with a remote device;

a motion sensor arrangement configured to detect motion data pertaining to the device;

at least one display element configured to render the information; and

a controller unit coupled to the communication module, the motion sensor arrangement, and the at least one display element, wherein the controller unit is configured to:

receive the information to be rendered from the remote device, via the communication module;

receive the motion data pertaining to the device from the motion sensor arrangement;

analyse the motion data pertaining to the device;

select at least one of the at least one display element to render the information, based upon the analysed motion data; and

render the information at the selected at least one display element.

In another aspect, an embodiment of the present disclosure provides a method for managing information, via a device comprising a communication module, a motion sensor arrangement, at least one display element and a controller unit, the method comprising:

receiving the information to be rendered from a remote device, via the communication module;

receiving motion data pertaining to the device from the motion sensor arrangement;

analysing the motion data pertaining to the device;

selecting at least one of the at least one display element to render the information, based upon the analysed motion data; and

rendering the information at the selected at least one display element.

The present disclosure provides the aforementioned device and the aforementioned method for managing information. The device described herein is simple, robust, inexpensive, and allows for managing the information in an efficient manner. The device efficiently presents information to people, and obtains feedback therefrom, in a manner that is simple, effective, and interactive. Moreover, the device does not have dedicated space and installation requirements and can therefore be employed very conveniently in retail environments. Furthermore, the method described herein is versatile, simple, easy to implement, and allows for substantially improving a person's experience within the retail environments.

Throughout the present disclosure, the term “information” used herein relates to meaningful data that is to be presented (namely, conveyed) to a person. In such an instance, the information is presented to the person by employing the aforesaid device. Furthermore, the information could be in form of text, image, audio, video, or any combination thereof.

Optionally, the device has a shape selected from the group consisting of: a triangular prism, a cube, a cuboid, a cylinder, a pyramid, a cone, a hexagonal prism, a hemisphere.

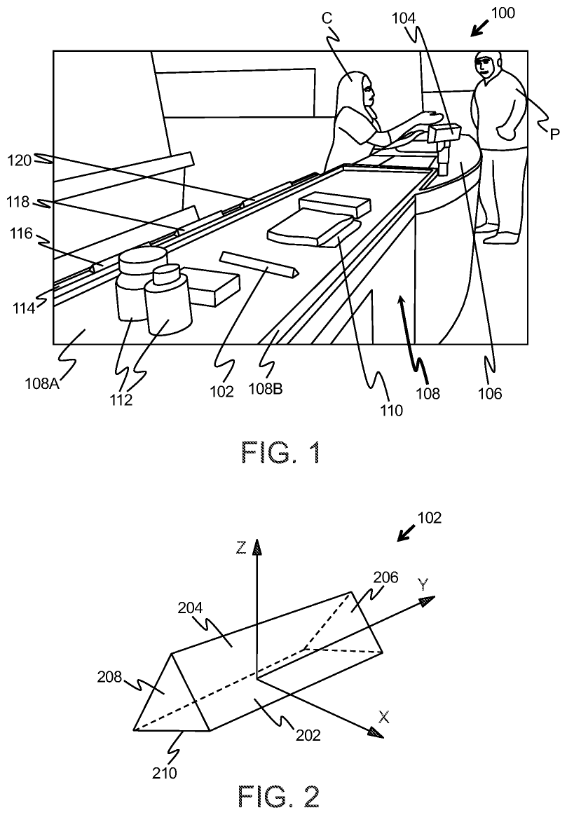

Optionally, the device is a checkout divider employed in a retail environment, and the information comprises at least one of: an advertisement of a product and/or a service, ongoing and/or upcoming events at the retail environment, a visual stimulus to be presented to a person for obtaining a feedback from the person. Optionally, in this regard, the person is a customer (namely, a buyer) of the retail environment. Throughout the present disclosure, the term “retail environment” used herein relates to a setting (namely, a location) whereat products and/or services are sold for commercial purposes. Examples of the retail environment include, but are not limited to, a grocery store, a convenience store, a pharmacy, a drugstore, and a supermarket. One such retail environment has been shown in conjunction with FIG. 1, as elucidated in detail below.

As an example, the device may be employed in a convenience store. In such an instance, the information may comprise details of ongoing discounts offered by the convenience store, for example, such as a 25 percent discount on all snacks and beverages.

Optionally, the retail environment comprises a cash register for registering transactions, wherein the cash register is installed at a point of sale (for example, such as a checkout counter) within the retail environment.

Furthermore, optionally, the retail environment comprises a conveyor belt arrangement arranged at the point of sale, wherein the conveyor belt arrangement is employed to transport items purchased by the person to a cashier managing the cash register. Optionally, the conveyor belt arrangement comprises a conveyor belt arranged on a track. In such an instance, the track is a mechanical frame configured to support at least the conveyor belt thereupon. Furthermore, optionally, the conveyor belt arrangement comprises mechanical components (for example, such as pulleys, motors, rollers, and so forth) configured to move the conveyor belt in a desired manner. In this regard, the conveyor belt could be moved in a manner that there is acceleration of the conveyor belt from rest up to a given speed, movement of the conveyor belt at the given speed for a period of time, and consequently deceleration of the conveyor belt from the given speed down to rest. It will be appreciated that the track could support such mechanical components thereupon.

Optionally, the conveyor belt arrangement is operated automatically. In such an instance, the conveyor belt arrangement comprises a light source and a light detector arranged at opposite sides of the track, wherein the light source is configured to emit a light beam across the conveyor belt towards the light detector, and the light detector is configured to receive the emitted light beam. Therefore, in an instance when an item arranged on the conveyor belt blocks the emitted light beam, the light detector is unable to receive the emitted light beam, and consequently, the conveyor belt stops moving. It will be appreciated that the light source and the light detector are arranged along a direction that is substantially perpendicular to a direction of motion of the conveyor belt. Alternatively, optionally, the conveyor belt arrangement is operated manually. In such an instance, the cashier managing the cash register could control the operation of the conveyor belt arrangement.

Furthermore, throughout the present disclosure, the term “checkout divider” relates to equipment that is employed at the point of sale within the retail environment, to separate one person's items from another person's items. Notably, the checkout divider is placed upon the conveyor belt, between items of different persons. Therefore, it will be appreciated that when the conveyor belt is in motion, the checkout divider placed thereupon also moves. Beneficially, the checkout divider allows for the cashier managing the cash register to distinguish between the items of different persons, and manage transactions at the cash register accordingly.

Optionally, a plurality of checkout dividers are employed in the retail environment. In such an instance, the track could comprise a groove running along a side thereof, wherein dimensions of the groove allow for accommodating the plurality of checkout dividers therein. Beneficially, unused (namely, spare) checkout dividers could be placed within the groove, thereby, allowing persons next in line to a person presently checking out from (namely, making a payment at) the retail environment, to use the spare checkout dividers whilst placing their own items on the conveyor belt. In this regard, the cashier and/or the persons could place unused checkout dividers within the groove.

Optionally, the point of sale within the retail environment is modelled in three dimensions. In other words, a three-dimensional coordinate system (namely, mutually perpendicular X, Y, and Z axes coordinate system) is employed to represent the three-dimensional space of the point of sale. More optionally, the origin of such a three-dimensional coordinate system is at the centre of the device, when the device is placed upon the conveyor belt. As an example, a positive X-axis direction may be employed to represent a direction of conventional motion of the conveyor belt, wherein the conveyor belt moves towards the cashier handling the cash register. Furthermore, Furthermore, a positive Z-axis may be employed to represent a direction opposite to direction of gravitational pull. One such three-dimensional system employed to model the retail environment and its orientation with respect to the device has been shown in conjunction with FIG. 2, as elucidated in detail herein.

As mentioned previously, the communication module is configured to communicate with the remote device. Throughout the present disclosure, the term “communication module” used herein relates to hardware, software, firmware, or combination of these, suitable for communicating with the remote device over a network. In an embodiment, the communication module communicates with the remote device wirelessly. In another embodiment, the communication module communicates with the remote device in a wired manner. In an example, the communication module may be a transceiver unit.

Furthermore, optionally, the communication module is suitable for communication over the network such as, but not limited to, a cellular network, short range radio (for example, such as Bluetooth®), Internet, a wireless local area network, and an Infrared Local Area Network.

It will be appreciated that the communication module of the device is compatible with a communication module of the remote device, in order to facilitate proper communication therebetween.

Throughout the present disclosure, the term “remote device” used herein relates to equipment that is positioned away from (namely, at a distance from) the device. In an example, the remote device may be positioned away from the retail environment, at a remote location. In another example, the remote device may be positioned within the retail environment, away from the device (for example, such as in a central control room).

Optionally, the remote device is configured to store the information. Optionally, in this regard, the information may be stored on a memory unit of the remote device. Examples of the remote device include, but are not limited to, a server, a smart phone, a desktop computer, a laptop computer, a tablet computer, a personal digital assistant.

As mentioned previously, the motion sensor arrangement is configured to detect the motion data pertaining to the device. Throughout the present disclosure, the term “motion sensor arrangement” used herein relates to equipment that is configured to detect motion of the device. The motion sensor arrangement could be configured to detect at least one of: linear motion of the device, angular motion of the device, tilting of the device.

Optionally, the motion sensor arrangement is implemented by way of at least one of: an accelerometer, a gyroscope, a magnetometer. In such an instance, the accelerometer, the gyroscope, and the magnetometer could be single axis instruments or multi-axis instruments. As an example, the motion sensor arrangement may be implemented by way of a three-axis accelerometer. As another example, the motion sensor arrangement may be implemented by way of a single-axis accelerometer and a single-axis gyroscope.

Furthermore, optionally, the motion sensor arrangement is arranged at the centre of the device. Optionally, in this regard, the motion sensor arrangement is arranged at the origin of the three-dimensional coordinate system.

Optionally, the motion data pertaining to the device comprises at least one of: linear acceleration of the device, angular acceleration of the device, orientation of the device. Furthermore, optionally, in this regard, the linear acceleration, the angular acceleration, and the orientation of the device are modelled in the three-dimensions. In other words, the motion data optionally comprises at least one of: three-dimensional linear acceleration of the device, three-dimensional angular acceleration of the device, three-dimensional orientation of the device. It will be appreciated that greater the amount of the detected motion data, greater is the accuracy of the detected motion of the device.

Optionally, the motion data pertaining to the device is in analogue form. Alternatively, optionally, the motion data pertaining to the device is in digital form.

In a first example, the device may be the checkout divider employed in the retail environment. The device may have a triangular prism shape having five faces (specifically, two triangular faces and three rectangular faces). The device may be placed upon a stationary conveyor belt in the retail environment, following which the conveyor belt is moved. Consequently, the device arranged upon the conveyor belt is also moved. Therefore, the motion data pertaining to the device may comprise three-dimensional linear acceleration of the device. In such a case, the motion data may comprise X-axis, Y-axis, and Z-axis linear accelerations of the device. For example, the X-axis linear acceleration may be 0.25 metre per second squared, and the Y-axis and the Z-axis linear accelerations may be zero.

As mentioned previously, the at least one display element is configured to render the information. It will be appreciated that the at least one display element is arranged on outer surfaces of the device, and the information is rendered at the at least one display element in a manner that the rendered information is visible to the person. For example, the information may be rendered on a surface of the device that faces the person.

In an embodiment, a number of display elements of the device are equal to a number of surfaces (namely, faces) of the device. For example, the device may be cubical in shape, and the device may comprise six display elements, one for each face of the device. In another embodiment, the number of display elements of the device are less than the number of surfaces of the device. For example, the device may have the triangular prism shape having five faces (specifically, two triangular faces and three rectangular faces), and the device may comprise three display elements, one for each rectangular face of the device. In yet another embodiment, the number of display elements of the device are more than the number of surfaces of the device. In such a case, multiple display elements may be arranged on a single face of the device. For example, the device may have the cylindrical (namely, disk-like) shape having 3 faces (specifically, two circular faces and one curved rectangular surface), and the device may comprise four display elements, two for each circular face of the device.

Furthermore, optionally, the at least one display element is implemented by way of at least one of: a seven segment display, a Liquid Crystal Display (LCD), a Light Emitting Diode (LED) based display, an Electroluminescent Display (ELD), an Organic Light-Emitting Diode (OLED) based display.

Throughout the present disclosure, the term “controller unit” relates to hardware, software, firmware, or a combination of these, configured to control components of the device (such as the communication module, the motion sensor arrangement, the at least one display element, and so forth) for managing the information.

The controller unit is configured to receive the information to be rendered from the remote device, via the communication module. Optionally, the controller unit sends a request to the remote device, for obtaining specific information. Upon receiving such a request, the remote device retrieves the specific information from its memory unit, and sends the specific information to the communication module of the device. Alternatively, optionally, the remote device automatically sends the information to the device (specifically, to the communication module of the device).

Furthermore, the controller unit is configured to receive the motion data pertaining to the device from the motion sensor arrangement. Optionally, the motion sensor arrangement automatically sends the detected motion data to the controller unit. Alternatively, optionally, the controller unit prompts the motion sensor arrangement to send the motion data, and the motion sensor arrangement sends the data to the controller unit upon receiving such a prompt.

The controller unit is configured to analyse the motion data pertaining to the device. Optionally, the motion data is analysed to determine at least one of: movement of the device, orientation of the device, position of the device, mood of the person associated with the device. Therefore, the analysis relates to processing the motion data in order to determine at least one of the aforesaid parameters pertaining to the device.

Optionally, at least one of: the movement of the device, the orientation of the device, the position of the device, is determined with respect to the three-dimensional coordinate system employed to model the point of sale within the retail environment. More optionally, the at least one of the aforesaid parameters of the device are determined with respect to the conveyor belt.

Referring to the aforesaid first example, the motion data pertaining to the device may be analysed to determine the movement and the orientation of the device with respect to the conveyor belt. In such an instance, since positive X-axis linear acceleration is detected, the device may be determined to be moving in the positive X-axis direction. Furthermore, since the Y-axis and the Z-axis linear accelerations are zero, the device may be determined to be placed perpendicular to the direction of conventional motion of the conveyor belt. Specifically, upon analysis of the motion data, it may be determined that two of the rectangular faces are oriented perpendicular to the direction of conventional motion of the conveyor belt, and the third rectangular face is oriented towards the negative Z-axis direction (namely, towards the conveyor belt). Furthermore above information can be used to determine which information is displayed towards positive X-axis and which information is displayed towards a negative X-axis. This way a first set of information can be displayed with a display with display facing the positive X-axis and a second set of information can be displayed with a display facing the negative X-axis. This enables to render different set of information to a customers at different places next to conveyer belt.

In a second example, the motion data pertaining to the device may comprise two-dimensional linear acceleration of the device, wherein the X-axis linear accelerations is zero, and the Y-axis linear acceleration is detected. In such an instance, the motion data is analysed to determine the orientation of the device as being parallel to the positive X-axis direction (namely, the direction of conventional motion of the conveyor belt). Alternatively, if the motion data comprises that equal linear acceleration being detected in both the X-axis and the Y-axis directions, the device may be oriented at an angle of 45 degrees with respect to both the positive X-axis and the positive Y-axis directions.

In a third example, the motion data pertaining to the device may comprise three-dimensional linear acceleration of the device wherein the X-axis, the Y-axis, and the Z-axis linear accelerations are random (namely, having random magnitude and direction). In such an instance, the motion data is analysed to determine the position of the device as being in hands of the person since the person handling the device may move his/her hand in a random manner as compared to the conveyor belt that moves the device in a predefined manner.

In a fourth example, the motion data pertaining to the device may comprise three-dimensional linear acceleration of the device wherein the X-axis and the Y-axis linear accelerations are zero and the Z-axis linear acceleration is 4 metre per second squared, towards negative Z-axis direction. Furthermore, such a Z-axis linear acceleration may be detected for 0.4 second, after which the Z-axis linear acceleration may also be zero. In such an instance, the motion data is analysed to indicate mood of the person associated with the device as being unpleasant since the device may be kept fast and abruptly upon the conveyor belt by the person.

In a fifth example, the motion data pertaining to the device may be in analogue form and may comprise a waveform depicting variation in linear acceleration of the device with respect to time. In such an instance, for example, random variations in the linear acceleration may indicate that the device is in the hands of the person, and a first positive peak in the linear acceleration may indicate that the device is placed upon a surface (for example, such as the conveyor belt). Thereafter, the surface may be moved, and therefore a second positive peak and/or ripples in the linear acceleration may indicate motion of the device, when the device is placed upon the moving surface. Furthermore, in such an example, a negative peak in the linear acceleration may indicate deceleration of the surface and the device. Moreover, ripples in the linear acceleration may indicate movement, placement and/or removal of other items upon the surface. Furthermore, larger-amplitude ripples in the linear acceleration may indicate removal of the device from the surface, and a zero linear acceleration may indicate that the device is stationary. One such detected analogue motion data has been shown in conjunction with FIG. 5.

The controller unit is further configured to select at least one of the at least one display element to render the information, based upon the analysed motion data. It will be appreciated that such a selection takes into consideration the at least one aforesaid parameter determined by way of analysing the motion data, thereby, allowing for rendering the information in a manner that it is conveniently visible to the person.

As an example, the device may be a cuboidal checkout divider employed in a grocery store. The device may comprise 6 display elements, one for each face thereof. The motion sensor arrangement of the device may detect motion data pertaining thereto, and such motion data may be analysed to determine orientation of the device with respect to a conveyor belt at the grocery store. Therefore, all display elements of the device, except the display element arranged on the face that is in contact with the conveyor belt, may be selected to render the information.

The controller unit is configured to render the information at the selected at least one display element. Optionally, the controller unit is configured to render same information at the selected at least one display element. Alternatively, optionally, the controller unit is configured to render different information at the selected at least one display element.

Optionally, the information is rendered when the device is placed upon the conveyor belt. Additionally or alternatively, optionally, the information is rendered when the device is held by (namely, lies in the hands of) the person.

Optionally, the rendered information comprises a visual stimulus to be presented to the person, and wherein the method further comprises obtaining a feedback from the person based upon the visual stimulus. Throughout the present disclosure, the term “visual stimulus” relates to visible (namely, capable of being seen) information, that invokes a reaction from the person viewing it. Optionally, the visual stimulus comprises at least one of: a question, an instruction, a suggestion. In such an instance, the question optionally pertains to the user's experience at the retail environment, the instruction optionally pertains to placing the device upon the conveyor belt in a certain orientation, and the suggestion optionally pertains to helpful recommendations for improving the user's experience at the retail environment.

Furthermore, optionally, the feedback is obtained by way of at least one of: recording the motion data pertaining to the device whilst the person handles the device, receiving an input from the person. In such an instance, the controller unit obtains the feedback by way of at least one of: the motion sensor arrangement, the at least one display element, the communication module. Optionally, the at least one display element is touch sensitive to receive the input from the person. Furthermore, optionally, the input of the person is at least one of: selection of a provided information at the at least one display element that is touch-sensitive, a personalized message of the person that is sent to the device via the communication module. Beneficially, the feedback is obtained to allow for future improvement in the service at the retail environment.

Moreover, optionally, upon obtaining the feedback (input from the person), the controller unit is configured to communicate the obtained feedback to the remote device, via the communication module. Optionally, in this regard, the controller unit is further configured to communicate the rendered information corresponding to the obtained feedback, to the remote device. Beneficially, the obtained feedback may be stored and analysed at the remote device to develop solutions for the future improvement in the service at the retail environment.

Optionally, the device further comprises a speaker module coupled to the controller unit, wherein the speaker module is configured to provide an audio output to the person. Optionally, the audio output is a standardised audio output, for example, such as “Thank you for your feedback”. Alternatively, optionally, the audio output is based upon the obtained feedback (input) from the person.

As an example, the device may be a cubical checkout divider employed in a supermarket. The device may comprise six display elements, one for each face thereof. The motion data pertaining to the device may be analysed to determine that the device is in the hand of the person. Consequently, four out of the six faces of the cubical checkout divider may be selected for rendering the information, based upon the analysed motion data. The information comprising a visual stimulus may be rendered at the selected four display elements when the device is in the hand of the person. In such a case, the visual stimulus may comprise a question, for example such as “How was your shopping experience today?” and three instructions, for example, such as “Place this face downwards if you had a great shopping experience”, “Place this face downwards if you think the checkout queue was too long”, and “Place this face downwards if you found items in the store easily”. It will be appreciated that the question and the three instructions may be rendered separately at the four selected display elements. In such an example, the feedback is obtained by recording the motion data pertaining to the device when the person handles the device to place a face having the visual stimulus “Place this face downwards if you had a great shopping experience” downwards, upon the conveyor belt. Furthermore, in such an example, the speaker module of the device may provide an audio output “We are glad you enjoyed shopping with us” to the person, based upon the obtained feedback.

Optionally, the device further comprises a haptic element configured to provide haptic output to the person, when the person touches the device. In such an instance, the haptic element optionally comprises at least one touch sensor (namely, tactile sensor) configured to detect touch (input) of the person on the device, and at least one mechanical component configured to provide the haptic output to the person. Examples of such at least one mechanical component include, but are not limited to, a motor, an actuator, and a spring. It will be appreciated that use of the haptic element beneficially allows for enhancing the person's experience of using the device.

As an example, the haptic element may be configured to provide the haptic output to the person by way of vibrating the device, when the person holds the device. Such a haptic output may draw attention of the person towards the information rendered at the device.

Optionally, the device further comprises a power source arrangement configured to provide electrical power to the communication module, the motion sensor arrangement, the at least one display element and the controller unit, wherein the power source arrangement comprises a battery unit. Optionally, the battery unit is non-rechargeable. In such a case, upon being fully discharged, the battery unit is discarded and is replaced with another battery unit that is charged. Alternatively, optionally, the battery unit is rechargeable. In such a case, after getting discharged, the battery unit is recharged by providing electrical power thereto.

Optionally, the power source arrangement further comprises a charging arrangement to provide the electrical power from a power supply source to the battery unit, and wherein the charging arrangement is implemented by way of at least one of: a power supply cable configured to be operatively and detachably attached to the power supply source and the battery unit, at least one conducting surface associated with the battery unit that is inductively coupled to at least one conductive surface of the power supply source. Additionally or alternatively, optionally, the charging arrangement is implemented by way of at least one inductive loop arranged within the device that is inductively coupled to at least one inductive loop arranged within the power supply source. In the aforesaid instances, the battery unit is rechargeable. It will be appreciated that the charging arrangement could be wired, wireless, or any combination thereof.

Furthermore, the power supply source is optionally configured to provide at least one charging voltage for provision of the electrical power to the battery unit. In such an instance, a given charging voltage employed for providing electrical power to a given battery unit depends upon a charging capacity and/or a charging rate of the given battery unit. For example, a single power supply source may be configured to provide 3 volts and 5 volts charging voltage for provision of the electrical power to the battery unit.

In one implementation, the charging arrangement is implemented by way of the power supply cable configured to be operatively and detachably attached to the power supply source and the battery unit. In such an instance, the power source may be for example, mains electricity plugs and sockets of the retail environment. Therefore, power supply cable could be operatively attached to the battery unit (or a charging port associated therewith) and attached to (namely, plugged into) a mains electricity socket provided at the point of sale in the retail environment. Optionally, upon completion of recharging of the battery unit, the power supply cable may be detached from the mains electricity socket and the battery unit.

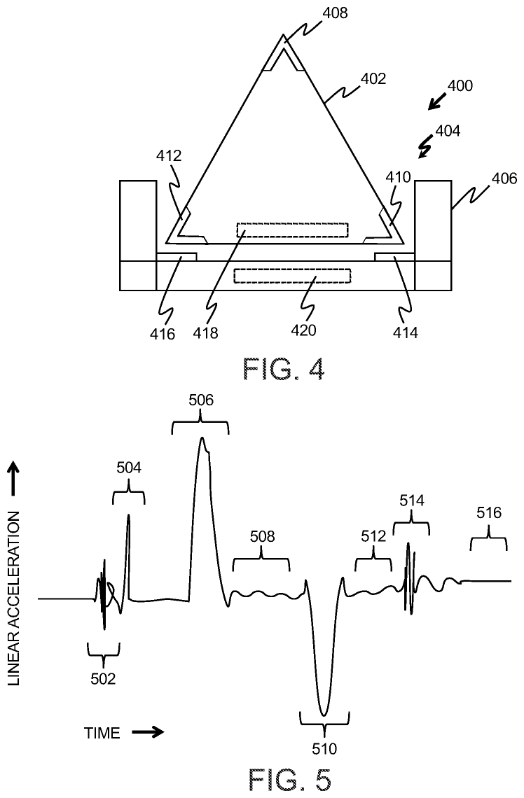

In another implementation, the charging arrangement is implemented by way of at least one conducting surface associated with the battery unit that is inductively coupled to at least one conductive surface of the power supply source. Optionally, the at least one conducting surface associated with the battery unit is disposed on at least one of: a corner (namely, a vertex) and/or an outer surface (namely, a face) of the device. Furthermore, optionally, the at least one conductive surface of the power supply source is implemented as at least surface at the point of sale within the retail environment, for example, such as a surface along a boundary (namely, side edges) of the track, a surface of a base (namely, a flat surface underneath the conveyor belt) of the track, and so forth. In such an instance, the track comprising the at least one conductive surface serves as the power supply source for the device, wherein the track receives the electrical power from mains electricity supply and provides the electrical power to the device. Moreover, the conducting surfaces of the power supply source and the battery unit may include inductive loops (namely, coils) therein, to allow for implementation of the aforesaid inductive coupling by forming a transformer when placed in proximity to each other. Therefore, in such a case, the electrical power is transferred from the at least one conductive surface of the power supply source to the at least one conductive surface of the device, wirelessly. One such power source arrangement has been shown in conjunction with FIG. 4. It will be appreciated that a number of conducting surfaces associated with the battery unit and a number of conducting surfaces of the power supply source, depend upon total power requirement of the device.

Moreover, optionally, the controller unit is configured to control operation of the power source arrangement. Optionally, the controller unit measures a polarity of a requisite charging voltage that is to be supplied by the power supply source to charge the battery unit, prior to recharging. In such an instance, the device could be placed in any orientation upon the conveyor belt, and the requisite charging voltage having the suitable polarity is provided to the battery unit thereof. Additionally or alternatively, optionally, the controller unit is configured to employ the analysed motion data to determine which conductive surface of the device is proximal to which conductive surface of the power supply source. Therefore, a suitable polarity of the requisite charging voltage is provided at the at least one conductive surface of the power supply source, wherefrom the electrical power is transferred to the at least one conductive surface associated with the battery unit.

It will be appreciated that the power source arrangement could employ renewable and/or non-renewable sources of energy for providing the electrical power to constituent components of the device. Examples of such sources of energy include, but are not limited to, solar energy, wind energy, thermal energy, and movement-based energy.

Optionally, the device further comprises a proximity sensor configured to detect an identification module associated with the person to determine an identity of the person, and wherein the controller unit is configured to render personalized information at the selected at least one display element, based upon the determined identity of the person. In such an instance, the identity module associated with the person may be embedded on an item or a tag carried by the person, for example, such as an RFID tag on the person's wallet, the person's credit/debit/loyalty card, the person's mobile phone, and so forth. In such an instance, rendering of the personalized information at the selected at least one display element enhances user engagement with the device. Further optionally, the device comprises a camera configured to capture image of a face of person(s) next to convey belt. The capture image of a face can be processed using facial recognition algorithms. This information can be used as an identity to provide personalized information. In addition or alternatively a camera can be installed to monitor persons along the convey belt as a separate camera unit. The separate camera unit can provide identity information in order to provide personalized information.

As an example, the proximity sensor (or camera) may determine an identity of a person P1, wherein the person P1 is a teenage boy. In such an instance, the controller unit may render personalized information, for example, such as ongoing discounts on sports shoes, an advertisement for a virtual reality game, and so forth, based upon the determined identity of the person P1. Furthermore, in such an example, the proximity sensor (or camera) may also determine an identity of another person P2, wherein the person P2 is a stay-at-home mother of two children. In such an instance,, the controller unit may render personalized information, for example, such as upcoming discounts on groceries, advertisements for home improvement, and so forth, based upon the determined identity of the person P2.

Optionally, the controller unit is further configured to measure an efficiency of the cashier handling the cash register at the point of sale within the retail environment, based upon the analysed motion data. In such a case, at least one of: a total distance moved by the device, a number of times the divider is placed upon and/or removed from the conveyor belt, could be employed to indicate a number of persons that made transactions at the point of sale. Further the analysed movement data can be used to make estimation of efficiency of the person operating the cash register. Further the analysed movement data can be used to make an estimation of average number of items per customer. As an example if distance between two consecutive devices is short an amount of items is small and if the distance is long amount of items is higher.

Optionally or additionally the device might comprise a camera to detect if a person has been paying attention to the device or not. As an example the device can be configured to record how many persons during the day took a look on information rendered in the device and for how long time. This can be implemented for example using face recognition algorithms combined with eye direction detection. The statistical information related to the viewing of the information can be communicated to back end system for analytics purposes. The statistical information can be collected to remote device/server.

Optionally or additionally the device might comprise means for detecting information related to items in the convey belt. The means might include radio frequency reader (RFID reader in practice), two-dimensional (quick response code QR-code), bar-code reader, or camera. The information related to items can be collected to remote device/server.

Optionally or additionally the point of sales might have an additional survey device comprising a display and input means at the end of the convey belt or after the cash register for a person to give further feedback on the service. The feedback from the additional survey device can be bundled with information collected with the checkout divider device.

Optionally the device might be configured to provide all or partial motion data to remote device/server for analysis i.e. the analysis of movement data can be made in server system.

The present disclosure also relates to the method as described above. Various embodiments and variants disclosed above apply mutatis mutandis to the method.

Referring to FIG. 1, illustrated is a schematic illustration of an environment 100 for using a device 102 for managing information, in accordance with an embodiment of the present disclosure. As shown, the environment 100 is a retail environment, for example, such as a supermarket. Furthermore, as shown, the environment 100 comprises a cash register 104 for registering transactions, wherein the cash register 104 is installed at a point of sale (for example, such as a checkout counter 106) within the environment 100. The environment 100 further comprises a conveyor belt arrangement 108 arranged at the point of sale 106. The conveyor belt arrangement 108 is employed to transport items 110 purchased by a person P to a cashier C managing the cash register 104. The conveyor belt arrangement 108 comprises a conveyor belt 108A arranged on a track 108B. As shown, the device 102 is optionally a checkout divider that is employed at the point of sale 106 within the environment 100 to separate the person P′s items 110 from another person's (not shown) items 112. Notably, the device 102 is placed upon the conveyor belt 108A, between the items 110 and 112. Furthermore, as shown, the track 108B comprises a groove 114 running along a side thereof, for accommodating unused (namely, spare) devices 116, 118, and 120 therein.

Referring to FIG. 2, illustrated is an orientation of the device 102 with respect to a three-dimensional coordinate system, in accordance with an embodiment of the present disclosure. As shown, the device 102 has a triangular prism shape, having five faces 202, 204, 206, 208, and 210, wherein the faces 202, 204, and 210 are rectangular faces whereas the faces 206 and 208 are triangular faces. The three-dimensional coordinate system could be employed to represent the three-dimensional space of the point of sale 106. In such an instance, the device 102 could be placed upon the conveyor belt 108A in the environment 100. Optionally, an origin of the three-dimensional coordinate system is at the centre of the device 102. In the depicted three-dimensional coordinate system, a positive X-axis direction is employed to represent a direction of conventional motion of the conveyor belt 108A, wherein the conveyor belt 108A moves towards the cashier C handling the cash register 104. In such an instance, the face 202 is oriented towards the positive X-axis direction, whereas the face 204 is oriented towards a negative X-axis direction. Furthermore, a positive Y-axis direction may be employed to represent a view direction of the person P when the person P faces the conveyor belt 108A (and the device 102 placed thereupon) in a manner that the conveyor belt 108A moves from a left side of the person P towards a right side of the person P. In such an instance, the face 206 is oriented towards the positive Y-axis direction, whereas the face 208 is oriented towards a negative Y-axis direction. Moreover, a positive Z-axis may be employed to represent a direction opposite to direction of gravitational pull. In such an instance, the face 210 is oriented towards the negative Z-axis direction.

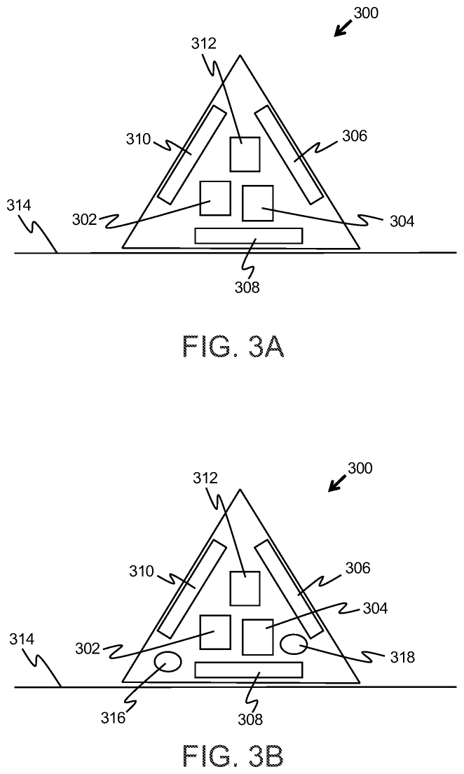

Referring to FIGS. 3A and 3B, illustrated are exemplary schematic illustrations of architectures of a device 300, in accordance with different embodiments of the present disclosure. It should be understood by a person skilled in the art that the FIGS. 3A and 3B include simplified architectures of the device 300 for the sake of clarity only, which should not unduly limit the scope of the claims herein. The person skilled in the art will recognize many variations, alternatives, and modifications of embodiments of the present disclosure.

The device 300 comprises a communication module 302 configured to communicate with a remote device (not shown), a motion sensor arrangement 304 configured to detect motion data pertaining to the device 300, at least one display element, depicted as display elements 306, 308, and 310, configured to render the information, and a controller unit 312 coupled to the communication module 302, the motion sensor arrangement 304, and the at least one display element 306-310. The controller unit 312 is configured to receive information to be rendered from the remote device, via the communication module 302; receive motion data pertaining to the device 300 from the motion sensor arrangement 304; analyse the motion data pertaining to the device; select at least one of the at least one display element 306-310 to render the information, based upon the analysed motion data; and render the information at the selected at least one display element, for example, such as the display element 310. Optionally, the device 300 could be placed upon a surface 314. In an example, the surface 314 is the conveyor belt 108A of FIG. 1.

In FIG. 3B, the device 300 further comprises a haptic element 316 configured to provide haptic output to a person, when the person touches the device 300. Furthermore, the device 300 further comprises a power source arrangement 318 configured to provide electrical power to the communication module 302, the motion sensor arrangement 304, the at least one display element 306-310 and the controller unit 312, wherein the power source arrangement 318 comprises a battery unit.

Referring to FIG. 4, illustrated is a schematic illustration of a power source arrangement 400 employed to provide electrical power to a device 402, in accordance with an embodiment of the present disclosure. The power source arrangement 400 comprises a battery unit (not shown) and a charging arrangement 404 to provide the electrical power from a power supply source 406 to the battery unit. As shown, for example, a track within a retail environment (not shown) serves as the power supply source 406 for the device 402, wherein the track receives the electrical power from mains electricity supply and provides the electrical power to the device 402. The charging arrangement 404 is implemented by way of at least one conducting surface (depicted as conducting surfaces 408, 410, and 412) associated with the battery unit that is inductively coupled to at least one conductive surface (depicted as conductive surfaces 414 and 416) of the power supply source 406. As shown, the conducting surface 410 is inductively coupled to the conducting surface 414 whereas the conducting surface 412 is inductively coupled to the conducting surface 416. Therefore, the electrical power is transferred from the conductive surfaces 414 and 416 of the power supply source 406 to the conductive surfaces 410 and 412 respectively, in a wireless manner. Additionally, the charging arrangement 404 is also implemented by way of at least one inductive loop (depicted as inductive loop 418) arranged within the device 402 that is inductively coupled to at least one inductive loop (depicted as inductive loop 420) arranged within the power supply source 406.

In a further embodiment of the invention, the arrangement for charging the devices is fitted with ultraviolet lights for disinfection of the surfaces of the devices. Such a disinfection arrangement can conveniently be implemented in a track that provides wireless charging for the devices. In a still further embodiment of the invention the devices are provided with an antibacterial coating to reduce the amount of bacteria living on any dirt or residue on the surface of a device. In an embodiment of the invention, the track further comprises a semi-enclosed portion through which the devices pass, and which portion comprises ultraviolet lights for desinfecting all surfaces of the devices while protecting customers and retail personnel from the ultraviolet radiation.

Referring to FIG. 5, illustrates is detected motion data pertaining to a device (for example, such as the device 102 of FIG. 1), in accordance with an embodiment of the present disclosure. As shown, the detected motion data is in analog form and comprises a waveform depicting variation in linear acceleration of the device with respect to time. As shown, motion data 502 depicts random variations in the linear acceleration, thereby, indicating that the device is in hands of a person. Furthermore, a first positive peak 504 in the linear acceleration may indicate that the device is placed upon a surface (for example, such as the conveyor belt 108A of FIG. 1). Thereafter, the surface may be moved. Therefore, a second positive peak 506 and ripples 508 in the linear acceleration may indicate motion of the device, when the device is placed upon the moving surface. Furthermore, a negative peak 510 in the linear acceleration may indicate deceleration of the surface and the device. Moreover, ripples 512 in the linear acceleration may indicate movement, placement and/or removal of other items upon the surface. Furthermore, larger-amplitude ripples 514 in the linear acceleration may indicate removal of the device from the surface, and a zero linear acceleration 516 may indicate that the device is stationary.

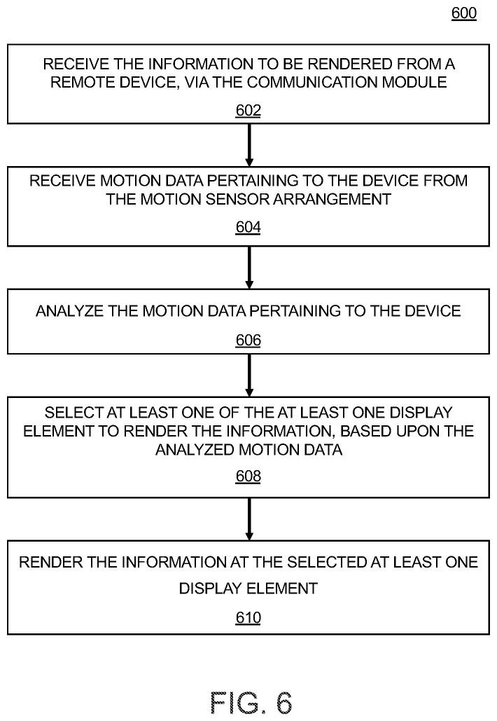

Referring to FIG. 6, illustrated are steps of a method 600 for managing information via a device, in accordance with an embodiment of the present disclosure. At step 602, the information to be rendered is received from a remote device, via a communication module. At step 604, motion data pertaining to the device is received from a motion sensor arrangement. At step 606, the motion data pertaining to the device is analysed. At step 608, at least one of the at least one display element is selected to render the information, based upon the analyzed motion data. At step 610, the information is rendered at the selected at least one display element.

The steps 602 to 610 are only illustrative and other alternatives can also be provided where one or more steps are added, one or more steps are removed, or one or more steps are provided in a different sequence without departing from the scope of the claims herein.

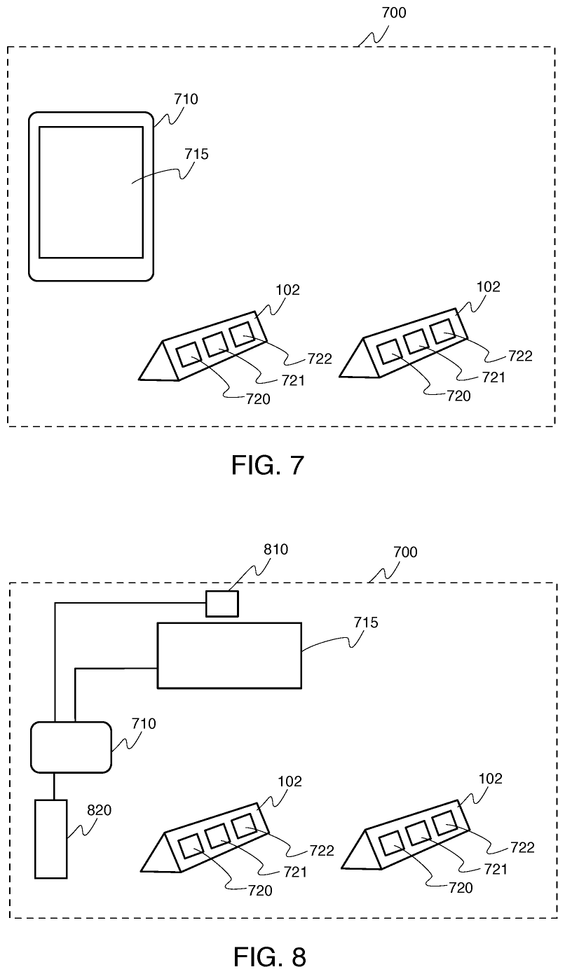

FIG. 7 illustrates a system 700 according to an embodiment of the invention. In the example of FIG. 7, the system comprises a computing device 710 that has a display 715, and devices 102 for interacting with a user. The devices 102 have a wireless data connection to the computing device 710 for transmitting information to the computing device and for receiving information from the computing device. The wireless data connection can be a WiFi connection, a Bluetooth connection, or any other wireless connection known to a man skilled in the art. The computing device 710 can for example be a tablet or a mobile computing device of another type such as a smartphone.

In an embodiment of the invention, the devices 102 for interacting with a user are checkout dividers at a retail point of sale location. In such an embodiment, the computing device 710 is advantageously placed so that customers can see the display 715 while handling a checkout divider 102.

In various embodiments of the invention, different types of media can be shown on the display 715 for the benefit of customers and for interaction with the customer. The system can for example provide simple games for amusement, whereby a customer can use the checkout divider to play the game. The media can be advertisements or short stories. The system can also provide questionnaires as games, or simply a questionnaire to provide feedback to the managers of the retail location.

In a further embodiment of the invention, the computing device 710 and the display 715 can be arranged to be separate devices. Such an embodiment is illustrated in FIG. 8. In the example of FIG. 8, the display 715 is separate from the computing device 710 but is connected to the computing device 710 with a wired connection such as a HDMI connection, a wired ethernet connection, or for example a wireless connection such as a WLAN connection. The display 715 can be for example a computer display or a television. In such an embodiment the display 715 is advantageously placed so that customers can see the display 715 while handling a checkout divider 102.

In the embodiment illustrated in FIG. 8, the computing device 710 may be a small personal computer, a tablet device, or for example a single board computer. The computing device 710 can have its own display in addition to being connected to the separate display 715.

In a further embodiment of the invention, the system comprises one or more loudspeakers for providing sound for a customer. Such loudspeakers can be for example loudspeakers within the housing of the separate display 715.

In a further embodiment, the system also comprises a camera 810 for observing the customers using the devices 102. The camera 810 can be implemented as a separate camera device 810 connected with a wired or wireless connection to the computing device 710. In a further embodiment, the camera 810 can be implemented using a camera integrated in the housing of the display device 715. In an embodiment with a camera, the computing device can analyze the camera feed in order to detect one or more of demographic attributes such as age or other attributes of a customer. In an embodiment of the invention, such detected attributes can be used in choosing which media to show to the customer, in order to entice the customer to interact with a device 102, or to enhance the customer's experience in interacting with a device 102. For example, the computing device can detect whether the customer is a teenager or an elder person and choose the media accordingly.

In a further embodiment of the invention, the computing device 710 is arranged to communicate with more than one device 102 at the same time. Such an embodiment can provide combined interaction of two or more users at a time, for example for playing a game shown on the display 715.

In a still further embodiment, the system further comprises a dispenser device controlled by the computing device 710. FIG. 8 illustrates a dispenser device 820. The dispenser device 820 is connected to the computing device 710 with a wired or a wireless connection. The dispenser device 820 is controlled by the computing device. In such an embodiment, the dispenser device can be used to release a product to a customer, for example as a prize after completing a game on the display 715 using a device 102, or a promotional product for any reason. The product could also be for example a coupon for providing a later benefit in the same business, or at a different business. The coupon could be a discount coupon, or for example a coupon providing a discount at a nearby fast food restaurant.

In a further embodiment of the invention, the dispenser device 820 comprises a printer for printing such coupons.

In certain further embodiments of the invention, the computing device is connected to a data communication network such as the internet for connection to a remote server in order to receive new media, games, and other instructions for interacting with customers, or for example software updates. Such a connection to a remote server can also provide information from the system 700 to the server. Such information can comprise for example information about the use of devices 102, or for example information about the stock of products in the dispenser device 820.

In certain embodiments of the invention, the devices 102 include such functionality as described previously in this specification with reference to devices 102 of FIGS. 1 to 6.

In further embodiments of the invention, the devices 102 are simpler devices than in the examples of FIGS. 1 to 6. In such embodiments, the system formed by the computing device 710 and checkout dividers 102 relies on both the devices 102 and the display 715 of the computing device 710 for interacting with a user. In such embodiments the devices 102 do not need to have a display, as information requiring use of a display can be shown on the display 715 of the computing device 710. Preferably, in such an embodiment, the device 102 for interacting with a user comprises a signalling element 720 for providing an indication to the user. The signalling element can provide an indication in different ways, for example as a light signal, a sound signal, or a vibration signal.

In further embodiments, the device 102 can comprise a microphone for detecting and/or recording sound. The device can also comprise an acceleration sensor for detecting movements of the device, for example to enable the use of the device as a controller for media or a game shown on the display 715. Further, the device can also comprise a NFC (near field communications) reader or a RFID (radio frequency identifier) reader for receiving information from a credit card, a customer loyalty card, or for example a smartphone of a customer. Further, the device can also comprise a location determination unit such as a GPS (global positioning system) circuit for determining the location of the device. Location information from such a unit can be used for example to detect theft of a device.

In further embodiments, the device 102 can comprise a sensor for detecting touch 721, or for example a sensor for detecting the presence of a user's hand 722. Further, the device 102 can comprise a sensor for detecting patterns in a user's hand in order to provide input which is different from user to another user. Such input can be used for example to provide fun interaction in the form of a palm reading and fortune teller game or application. The device 102 can further comprise any other sensor described in this specification with reference to FIGS. 1 to 6, such as an acceleration sensor.

In an embodiment of the invention providing a system illustrated in FIG. 7, the interaction with a user can employ sensor input from sensors of the device 102 signals provided by a signalling element of the device 102, and information shown on the display 715 of the computing device 710.

In a further embodiment of the invention the system comprising a computing device 710 and a plurality of devices 102 for user interaction comprises functionality for pairing a device 102 for user interaction with a computing device 710. In a typical retail environment there typically are multiple points of sale close to each other, whereby devices 102 or checkout dividers 102 from one point of sale could be in the wireless communication range of the computing device 710 of a neighboring point of sale. Functionality for pairing of checkout dividers used at a particular point of sale with the mobile device of that particular point of sale would ensure that the devices at that point of sale communicate coherently with each other, without disturbing other points of sale.

In an embodiment of the invention, each of the devices 102 for user interaction comprises an NFC (near field communication) tag, which can be read by the computing device 710 for identifying the device 102 for user interaction by the computing device 710.

In a further embodiment of the invention, each of the devices 102 for user interaction has a bar code, a QR code, or another optical marking which can be read by a camera or a barcode reader of the computing device 710.

The inventive system provides many different possibilities for interacting with shoppers. The inventive system allows gamification of the point of sale experience for users i.e. shoppers. For example, the inventive system can provide an interactive way to participate in a lottery or a game by informing the user on the screen of the computing device that the user can participate in a game or a lottery by e.g. shaking the checkout divider 102. For a further example, the user can use the checkout divider 102 like a game controller, and select a given choice by moving the checkout divider.

As the computing device 710 is intended to be viewable by the users i.e. shoppers, the computing device is also able to view the shoppers and their purchases using a front camera of the computing device. In an embodiment of the invention the computing device analyzes the view of the front camera and uses analysis results for controlling an aspect of the interaction with the user. For example, the computing device can be arranged to analyze how much purchases a customer has, and reward a customer with a large amount of purchases with a better lottery or another reward than a customer with one or two purchases only. Further, the computing device can be arranged to perform face analysis of the customer to determine an approximate age, sex, or other factors pertaining to the customer, and adjust content showed to the customer as a response.

In a further embodiment of the invention, a device 102 for user interaction such as a checkout divider 102 can have an operating mode with very low current consumption for saving battery energy during periods of waiting for the next user. In such an operating mode, the device can monitor for movement based on its acceleration sensor and return to a full operating mode upon determination of an acceleration event e.g. when a user moves the checkout divider on the belt of the point of sale.

Further, if the battery of the device 102 for user interaction is drained below a predetermined level, the device 102 in a further embodiment of the invention communicates this status to the computing device 710, which can then inform the cashier or the information system of the retailer that this particular device 102 needs charging.

In a further embodiment of the invention, the device 102 for user interaction comprises a bar code reader for checking the bar code of a product, in order to allow the customer to check the price of an object to be purchased.

In the following, we describe a number of embodiments of the invention.

According to a first aspect of the invention, a device for interaction with a user is provided. In a first embodiment of this first aspect of the invention, the device comprises:

a communication module configured to communicate with a remote device over a wireless connection,

a motion sensor arrangement configured to detect motion data pertaining to the device,

at least one signaling element for providing an indication to a user of the device, and

a controller unit coupled to the communication module, the motion sensor arrangement, and the at least one signaling element, wherein the controller unit is configured to:

receive the motion data pertaining to the device from the motion sensor arrangement;

analyze the motion data pertaining to the device;

transmit a result of said analysis to said remote device, via the communication module;

receive information about an indication to be provided to a user of the device, via the communication module, and

provide an indication to a user via a signaling element based at least in part on said received information.

In a second embodiment according to this first aspect of the invention, said indication is a light signal, a sound signal, or a vibration signal.

In a third embodiment according to this first aspect of the invention, the device is a checkout divider employed in a retail environment.

In a fourth embodiment according to this first aspect of the invention, the device further comprises at least one display element configured to render the information; and said controller unit is configured to:

receive the information to be rendered from the remote device, via the communication module;

receive the motion data pertaining to the device from the motion sensor arrangement;

analyze the motion data pertaining to the device;

select at least one of the at least one display element to render the information, based upon the analyzed motion data; and

render the information at the selected at least one display element.

According to a second aspect of the invention a system for interacting with a user is provided. In a first embodiment according to this second aspect of the invention, the system comprises:

a computing device having a display;

at least one device for interaction with a user, the device comprising:

a communication module configured to communicate with said computing device over a wireless connection;

a motion sensor arrangement configured to detect motion data pertaining to the device;

at least one signaling element for providing an indication to a user of the device,

a controller unit coupled to the communication module, the motion sensor arrangement, and the at least one signaling element, wherein the controller unit is configured to:

receive the motion data pertaining to the device from the motion sensor arrangement;

analyze the motion data pertaining to the device;

transmit a result of said analysis to said computing device, via the communication module;

receive information about an indication to be provided to a user from said computing device via the communication module, and

provide an indication to a user via a signalling element based at least in part on said received information,

said computing device being arranged to display information on said display to a user based on information received from said device for interaction with a user.

In a second embodiment according to this second aspect of the invention, said device for interaction with a user is a checkout divider employed in a retail environment.

In a third embodiment according to this second aspect of the invention, said system further comprises:

at least one display element in said device for user interaction configured to render information received from the computing device; and

wherein the controller unit of said device for user interaction is configured to:

receive the information to be rendered from the remote device, via the communication module;

receive the motion data pertaining to the device from the motion sensor arrangement;

analyze the motion data pertaining to the device;

select at least one of the at least one display element to render the information, based upon the analyzed motion data; and

render the information at the selected at least one display element.

In view of the foregoing description, it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another but are to be considered as separate and autonomous representations of the present invention.

Furthermore, the described features, structures, or characteristics may be combined in any suitable manner in one or more embodiments. In the previous description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A device for interaction with a user, the device comprising:
a communication module configured to communicate with a remote device over a wireless connection;
a motion sensor arrangement configured to detect motion of the device within a retail checkout environment and provide motion data pertaining to the device;
at least one signaling element for providing an indication to a user of the device, and
a controller unit coupled to the communication module, the motion sensor arrangement, and the at least one signaling element;
wherein the controller unit is configured to:
receive the motion data pertaining to the device from the motion sensor arrangement;
analyze the motion data pertaining to the device;
transmit a result of said analysis to said remote device, via the communication module; receive information about an indication to be provided to a user of the device, via the communication module;
provide an indication to a user via a signaling element based at least in part on said received information; and
wherein the device is a checkout divider employed in a retail environment.

2. The device according to claim 1, wherein said indication is a light signal, a sound signal, or a vibration signal.

3. The device according to claim 1, further comprising:
at least one display element configured to render the information; and
wherein the controller unit is configured to:
receive the information to be rendered from the remote device, via the communication module;
receive the motion data pertaining to the device from the motion sensor arrangement;
analyze the motion data pertaining to the device;
select at least one of the at least one display element to render the information, based upon the analyzed motion data; and
render the information at the selected at least one display element.

4. A system for interacting with a user, the system comprising:
a computing device;
display; and
at least one device for interaction with a user, the device comprising:
a communication module configured to communicate with said computing device over a wireless connection;
a motion sensor arrangement configured to detect motion of the device and provide motion data pertaining to the device;
at least one signalling element for providing an indication to a user of the device,
a controller unit coupled to the communication module, the motion sensor arrangement, and the at least one signalling element, wherein the controller unit is configured to:
receive the motion data pertaining to the device from the motion sensor arrangement;
analyse the motion data pertaining to the device;
transmit a result of said analysis to said computing device, via the communication module;
receive information about an indication to be provided to a user from said computing device via the communication module, and
provide an indication to a user via a signalling element based at least in part on said received information,
said computing device being arranged to display information on said display to a user based on information received from said device for interaction with a user; and
wherein said device for interaction with a user is a checkout divider employed in a retail environment.

5. The system according to claim 4, further comprising:
at least one display element in said device for interaction with a user configured to render information received from the computing device; and
wherein the controller unit of said device for user interaction is configured to:
receive the information to be rendered from the computing device, via the communication module;
receive the motion data pertaining to the device from the motion sensor arrangement;
analyze the motion data pertaining to the device;
select at least one of the at least one display element to render the information, based upon the analyzed motion data; and
render the information at the selected at least one display element.
